(19) United States
(12) Patent Application Publication
(10) Pub. No.: US 2026/0252025 A1
(43) Pub. Date: Aug. 27, 2026

(54) IMAGE FORMING APPARATUS

(71) Applicant: KYOCERA Document Solutions Inc., Osaka (JP)

(72) Inventor: Satoshi ANDO, Osaka (JP)

(73) Assignee: KYOCERA Document Solutions Inc., Osaka (JP)

(21) Appl. No.: 19/544,127

(22) Filed: Feb. 19, 2026

(30) Foreign Application Priority Data
Feb. 21, 2025 (JP) 2025-026704

(51) Int. Cl. G03G 21/16; G03G 15/08

(52) U.S. Cl. CPC G03G 21/1633; G03G 15/0865; G03G 21/1647; G03G 2221/1654; G03G 2221/169

(57) ABSTRACT

An image forming apparatus includes s main body, a container, an outer cover which includes a fitting region and an inner cover. When the container is not fitted into the fitting region, the inner cover is held in a first position, and when the container is fitted into the fitting region, the inner cover is pressed by the container to be displaced to a second position. The main body includes a restriction unit, and when the outer cover is turned to a closed position in a state where the inner cover is held in the first position, the inner cover abuts against the restriction unit to restrict the outer cover from reaching the closed position.

### INCORPORATION BY REFERENCE

This application is based upon and claims the benefit of priority from the corresponding Japanese Patent Application No. 2025-026704 (filed on Feb. 21, 2025), the entire contents of which are incorporated herein by reference.

### BACKGROUND

The present disclosure relates to an image forming apparatus which includes a container for storing a toner.

A conventional image forming apparatus uses a toner stored in a container to perform printing. The container is removable from the main body of the image forming apparatus. A cover which is attached to the main body of the image forming apparatus to be opened and closed is opened, and thus the container is removable from the main body.

### SUMMARY

An image forming apparatus according to an aspect of the present disclosure includes a main body, an outer cover and an inner cover. The main body includes a printing unit. The outer cover includes a container that stores a toner used for printing in the printing unit, is supported to be turnable around a first axis orthogonal to an up/down direction relative to the main body, includes a fitting region into which the container is removably fitted and is displaceable between an open position where the outer cover is turned around the first axis to expose the fitting region to an outside of the main body such that the container is removable from the fitting region and a closed position where the container in the fitting region is placed in the main body. The inner cover is supported to be turnable around a second axis parallel to the first axis relative to the outer cover, and sandwiches the container in the fitting region between the outer cover and the inner cover. The inner cover is displaceable between a first position and a second position relative to the outer cover. When the container is not fitted into the fitting region, the inner cover is held in the first position. When the container is fitted into the fitting region, the inner cover is pressed by the container to be displaced from the first position to the second position. The main body includes a restriction unit. When the outer cover is turned from the open position to the closed position in a state where the inner cover is held in the first position, the inner cover abuts against the restriction unit to restrict the outer cover from reaching the closed position.

### BRIEF DESCRIPTION OF THE DRAWINGS

FIG. 1 is a perspective view of an image forming apparatus according to an embodiment;

FIG. 2 is a perspective view in a state where one of outer covers shown in FIG. 1 is in an open position;

FIG. 3 is a schematic view showing the internal configuration of the image forming apparatus according to the embodiment;

FIG. 4 is a schematic view of an image formation unit shown in FIG. 3 and an area therearound;

FIG. 5 is a perspective view of a container which is fitted into the main body of the image forming apparatus according to the embodiment;

FIG. 6 is a perspective view of the fitting region of the image forming apparatus according to the embodiment and an area therearound;

FIG. 7 is a perspective view in a state where the container is fitted in the fitting region shown in FIG. 6;

FIG. 8 is an enlarged perspective view of the support point hole of the outer cover shown in FIG. 6 and an area therearound;

FIG. 9 is a diagram schematically showing the state where the outer cover in the image forming apparatus according to the embodiment is in the open position;

FIG. 10 is a diagram schematically showing a state where the outer cover in the image forming apparatus according to the embodiment is in a closed position;

FIG. 11 is a diagram schematically showing a state where an inner cover in the image forming apparatus according to the embodiment is in a first position;

FIG. 12 is a diagram schematically showing a state where the inner cover in the image forming apparatus according to the embodiment is in a second position;

FIG. 13 is a diagram schematically showing a state where an inner cover in an image forming apparatus according to a variation is in the first position;

FIG. 14 is a diagram schematically showing a state where the inner cover in the image forming apparatus according to the variation is in the second position;

FIG. 15 is a perspective view of the inner cover in the image forming apparatus according to the embodiment;

FIG. 16 is a schematic view showing the path of turning of a protrusion provided in the inner cover in the image forming apparatus according to the embodiment;

FIG. 17 is a schematic view of a state where the main body and the inner cover in the image forming apparatus according to the embodiment abut against each other;

FIG. 18 is a perspective view of the state where the main body and the inner cover in the image forming apparatus according to the embodiment abut against each other; and

FIG. 19 is a perspective view showing a positional relationship between the main body and the inner cover when the outer cover reaches the closed position without the inner cover abutting against the main body in the image forming apparatus according to the embodiment.

### DETAILED DESCRIPTION

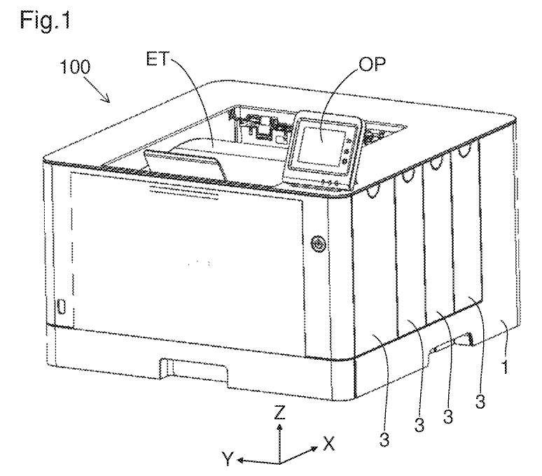

An image forming apparatus 100 in the present embodiment will be described below with reference to FIGS. 1 to 19. The image forming apparatus 100 is installed on a floor surface FL which is substantially horizontal and flat. A vertical direction which is perpendicular to the floor surface FL is an up/down direction in the image forming apparatus 100. One of horizontal directions is a forward/backward direction in the image forming apparatus 100, and the other direction orthogonal to the one direction is a left/right direction in the image forming apparatus 100.

In drawings referred to in the following description, for ease of understanding, an XYZ orthogonal coordinate system is shown. A Z direction is the vertical direction, and is the up/down direction in the image forming apparatus 100. The floor surface FL is a surface which is perpendicular to the Z direction. The direction of the arrow of the Z axis is an upward direction, and a direction opposite thereto is a downward direction.

An X direction is the one direction of the horizontal directions, and a Y direction is the other direction of the horizontal directions. For example, the X direction corresponds to the forward/backward direction in the image forming apparatus 100. The Y direction corresponds to the left/right direction in the image forming apparatus 100.

### Configuration of image forming apparatus

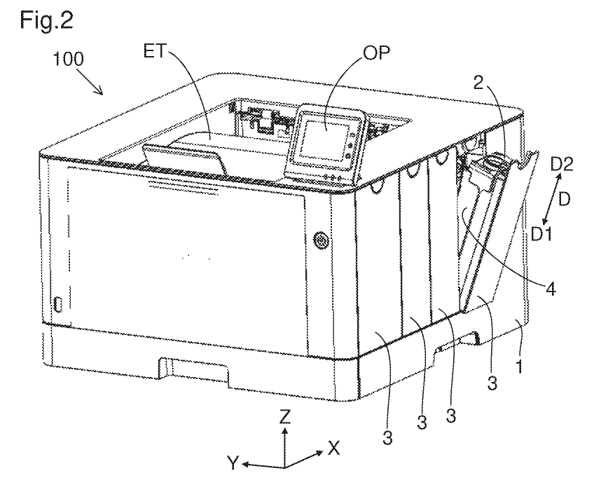

As shown in FIGS. 1 and 2, the image forming apparatus 100 includes a main body 1. The image forming apparatus 100 also includes containers 2. The containers 2 store toners used for printing. The containers 2 are fitted into the main body 1. The number of containers 2 fitted is four. A plurality of (four) containers 2 correspond cyan, magenta, yellow and black, respectively. The toner of the corresponding color is stored in each of the containers 2.

Each of the containers 2 is removable from the main body 1. A user manually performs an operation of fitting and removing the containers 2. For example, when one of the containers 2 is empty of the toner, the container 2 in the empty state is removed, and a new container 2 where the toner is stored is fitted.

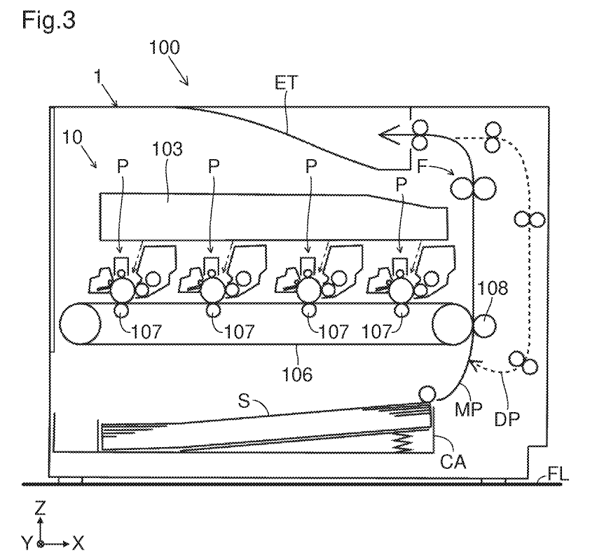

As shown in FIG. 3, the main body 1 includes a printing unit 10. The printing unit 10 prints an image on a sheet S. The sheet S used in the printing is stored in a sheet cassette CA. The sheet cassette CA is removably fitted into the main body 1.

The printing unit 10 includes a main conveyance path MP. The main conveyance path MP passes from the sheet cassette CA through a transfer position and a fixing position in this order, and reaches an ejection tray ET.

In the printing performed by the printing unit 10, the sheet S in the sheet cassette CA is supplied to the main conveyance path MP, and is conveyed along the main conveyance path MP. An image is formed using the toners. Then, the image is printed on the sheet S being conveyed. In other words, transfer processing (specifically, secondary transfer) for the image to the sheet S being conveyed is performed in the transfer position. In the fixing position, fixing processing for the image on the sheet S is performed.

The printing unit 10 includes four image formation units P which correspond to the colors of cyan, magenta, yellow and black, respectively. Each of the image formation units P forms an image using the toner of the corresponding color.

Although attention is forced on one of the image formation units P, and the configuration thereof will be described below, the configurations of the image formation units P are the same as each other. Hence, the description of the configurations of the other image formation units P is omitted because the following description can be used therefor.

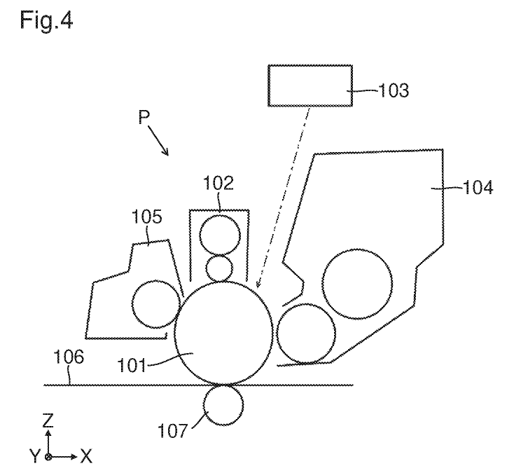

The image formation unit P has the configuration as shown in FIG. 4. The image formation unit P includes a photosensitive drum 101, a charging device 102, an exposure device 103, a development device 104 and a cleaning device 105.

The photosensitive drum 101 is supported to be rotatable around an axis extending in the left/right direction (Y direction). The photosensitive drum 101 is rotated while carrying a toner image on its outer circumferential surface. The charging device 102 charges the outer circumferential surface of the photosensitive drum 101. The exposure device 103 exposes the outer circumferential surface of the photosensitive drum 101 to form an electrostatic latent image on the outer circumferential surface of the photosensitive drum 101. The development device 104 receives the supply of the toner from the container 2 which stores the toner of the corresponding color. The development device 104 uses the toner to develop the electrostatic latent image on the outer circumferential surface of the photosensitive drum 101 into the toner image. The cleaning device 105 removes the toner left on the outer circumferential surface of the photosensitive drum 101.

As shown in FIG. 3, the printing unit 10 includes an intermediate transfer belt 106. The intermediate transfer belt 106 is a seamless belt. The intermediate transfer belt 106 is stretched over a plurality of tension rollers (symbols of which are omitted).

The intermediate transfer belt 106 is disposed such that its outer circumferential surface is in contact with the outer circumferential surfaces of the photosensitive drums 101. The toner images on the outer circumferential surfaces of the photosensitive drums 101 are primarily transferred to the outer circumferential surface of the intermediate transfer belt 106. The intermediate transfer belt 106 is rotated while carrying the toner images on the outer circumferential surface. In this way, the toner images on the outer circumferential surface of the intermediate transfer belt 106 are conveyed toward the transfer position.

The printing unit 10 includes primary transfer rollers 107. The four primary transfer rollers 107 are provided. The primary transfer rollers 107 are assigned to the photosensitive drums 101, respectively.

The printing unit 10 includes a secondary transfer roller 108. The secondary transfer roller 108 is pressed against the outer circumferential surface of the intermediate transfer belt 106 in the transfer position to form a transfer nip between the intermediate transfer belt 106 and the secondary transfer roller 108. The main conveyance path MP passes through the transfer nip.

In a print job, the sheet S is conveyed toward the transfer position (that is, the transfer nip). The image formation units P use the toners of the corresponding colors to form the toner images. The primary transfer rollers 107 primarily transfer the toner images to the outer circumferential surface of the intermediate transfer belt 106. The intermediate transfer belt 106 is rotated while carrying the toner images. The secondary transfer roller 108 secondarily transfers the toner images to the sheet S which is being passed through the transfer position.

The image forming apparatus 100 includes a fixing unit F. The fixing unit F includes a heating roller and a pressure roller. The heating roller incorporates a heater. The pressure roller is pressed against the heating roller. The heating roller and the pressure roller are pressed against each other to form a fixing nip in the fixing position.

In the print job, the sheet S is passed through the fixing position (that is, the fixing nip). The fixing unit F heats the sheet S which is being passed through the fixing position, and pressurizes the sheet S. The fixing unit F heats and pressurizes the sheet S to fix the toner images on the sheet S. The sheet S on which the fixing processing has been performed is ejected to the ejection tray ET.

The image forming apparatus 100 includes a double-sided printing conveyance path DP. In this way, the image forming apparatus 100 can perform a double-sided printing job for printing images on both surfaces of the sheet S in addition to a single-sided printing job for printing an image on only one surface of the sheet S.

The double-sided printing conveyance path DP branches from the main conveyance path MP in a branch position on a downstream side in a sheet conveyance direction relative to the fixing position in the main conveyance path MP. The double-sided printing conveyance path DP merges into the main conveyance path MP in a merging position on an upstream side in the sheet conveyance direction relative to the transfer position in the main conveyance path MP.

When the job to be performed is the single-sided printing job, the sheet S is passed through the transfer position only once, and the transfer processing is performed on the sheet S which is being passed through the transfer position. Then, after the first transfer processing, the sheet S is ejected to the ejection tray ET without being processed.

When the job to be performed is the double-sided printing job, the transfer processing is performed once on each of the front and back surfaces of the sheet S, and thus the sheet S is passed through the transfer position twice. Specifically, when the sheet S is passed through the transfer position for the first time, the transfer processing is performed on one surface of the sheet S. After the first transfer processing, the sheet S is switched back after the back end of the sheet S is passed through the branch position and before the sheet S is completely ejected to the ejection tray ET. In this way, the sheet S is drawn into the double-sided printing conveyance path DP from the back end.

Thereafter, the sheet S is conveyed along the double-sided printing conveyance path DP, and is returned from the merging position to the main conveyance path MP. In this way, the sheet S is passed through the transfer position again. Here, the orientation of the front and back surfaces of sheet S is reversed relative to the orientation thereof when the sheet S is passed through the transfer position last time. Consequently, when the sheet S is passed through the transfer position for the second time, the transfer processing is performed on the other surface opposite to the one surface of the sheet S.

### Holding mechanism of container

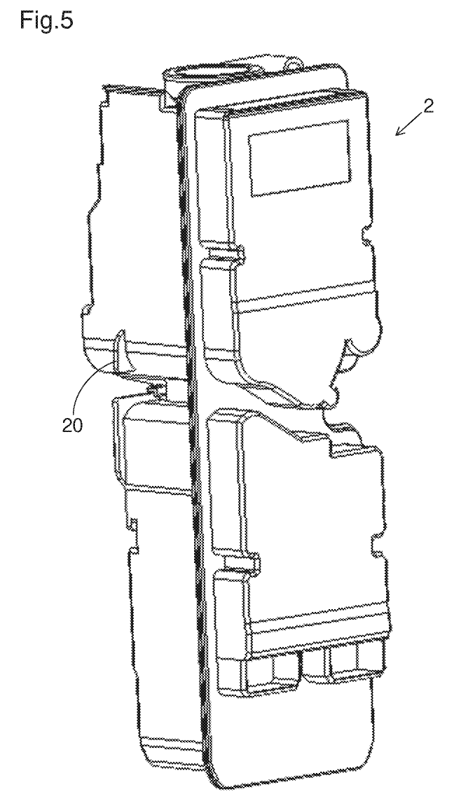

The container 2 has an appearance as shown in FIG. 5. The basic configurations of the containers 2 are the same as each other. However, the capacity of the container 2 for storing the toner of black may be larger than the capacities of the containers 2 for storing the toners of the other colors.

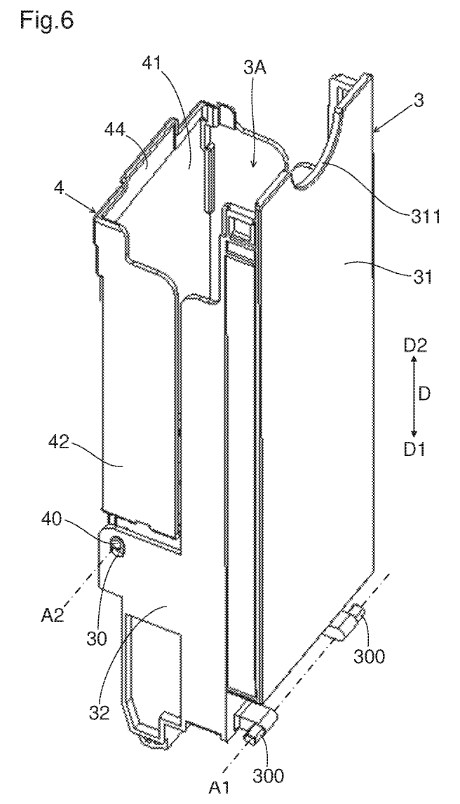

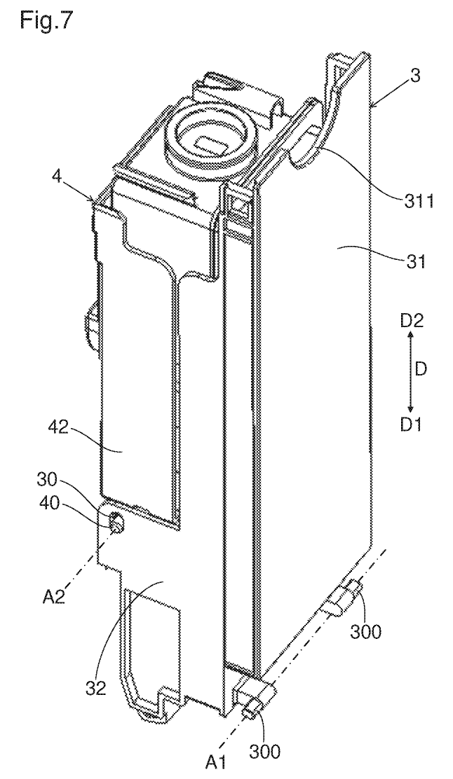

In order to hold the container 2, a holding mechanism as shown in FIGS. 6 and 7 is used. The container 2 is held by an outer cover 3 and an inner cover 4. In other words, the image forming apparatus 100 includes the outer cover 3 and the inner cover 4. FIG. 6 shows a state where the container 2 is removed, and FIG. 7 shows a state where the container 2 is fitted.

The holding mechanism as shown in FIGS. 6 and 7 is assigned to each of the containers 2. In other words, the outer cover 3 is assigned to each of the containers 2. Likewise, the inner cover 4 is assigned to each of the containers 2.

The outer cover 3 is made of resin. The outer cover 3 may be made of sheet metal. The outer cover 3 is a part of an exterior which covers the inside of the main body 1 from an outer side. In other words, the outer cover 3 includes an exterior surface 31.

The outer cover 3 is attached to the main body 1 to be opened and closed. When the user performs the operation of fitting and removing the container 2, the outer cover 3 is manually opened and closed. For example, the outer cover 3 includes, as a handle 311, a part which is cut downward from the upper edge of the exterior surface 31. When the outer cover 3 is opened or closed, a finger of the user is placed on the handle 311.

The outer cover 3 is supported to be turnable around a first axis A1 relative to the main body 1. The outer cover 3 is turned around the first axis A1 to be opened and closed. The first axis A1 is an axis which extends in the forward/backward direction (X direction). In other words, the first axis A1 is an axis which is orthogonal to the up/down direction.

The outer cover 3 includes a pair of support point pins 300. Each of the pair of support point pins 300 is disposed on the first axis A1, and extends in the axial direction of the first axis A1. On the other hand, the main body 1 includes a pair of support point holes which are not shown in the figure. Each of the pair of support point holes in the main body 1 is disposed on the first axis A1, and is opened in the axial direction of the first axis A1. The pair of support point pins 300 are fitted into the pair of support point holes in the main body 1, respectively. Each of the pair of support point pins 300 is slidable around the first axis A1 relative to the support point hole into which the support point pin 300 is fitted. In this way, the outer cover 3 is turnable with the first axis A1 serving as a support point.

The outer cover 3 includes a fitting region 3A on the side of the back surface of the exterior surface 31 (that is, the inner side of the main body 1). The container 2 is fitted into the fitting region 3A. The container 2 is removable from the fitting region 3A. The outer cover 3 is displaced around the first axis A1, and thus it is possible to cause the outer cover 3 to reach a position where the container 2 is removable.

Specifically, the outer cover 3 is turned around the first axis A1 to be displaceable between an open position and a closed position. In the open position, the outer cover 3 is opened, and in the closed position, the outer cover 3 is closed.

In a state where the outer cover 3 is in the closed position, the inside of the main body 1 is covered from the outer side. The fitting region 3A is also placed in the main body 1. In other words, the container 2 in the fitting region 3A is fitted in the main body 1. Furthermore, in other words, the container 2 fitted in the main body 1 is covered by the outer cover 3 from the outer side of the main body 1.

In the state where the outer cover 3 is in the closed position (that is, in the state where the container 2 is fitted in the main body 1), the container 2 is located inside the main body 1. The container 2 and the development device 104 are connected via a toner distribution path (not shown). In this way, the toner can be supplied from the container 2 to the development device 104.

In a state where the outer cover 3 is in the open position, the inside of the main body 1 is exposed. The fitting region 3A is also exposed to the outside of the main body 1. In other words, the container 2 in the fitting region 3A is exposed to the outside of the main body 1. In this way, the container 2 is removable from the fitting region 3A. The outer cover 3 is in the open position such that the container 2 is removable from the fitting region 3A.

The rotation angle of the outer cover 3 between the open position and the closed position about the first axis A1 is less than 90°, and the outer cover 3 cannot be opened at an angle equal to or greater than 90°. For example, in FIG. 2, the position of the container 2 which is present on the rearmost side of the image forming apparatus 100 is the open position.

Hence, the direction D of fitting and removal of the container 2 relative to the fitting region 3A is inclined relative to the up/down direction and the horizontal direction. In other words, when the container 2 is fitted into the fitting region 3A, the container 2 is moved diagonally downward. When the container 2 is removed from the container 2, the container 2 is moved diagonally upward.

The direction D of fitting and removal of the container 2 is a direction in which the container 2 is moved when the container 2 is fitted into or removed from the fitting region 3A. When the container 2 is fitted into or removed from the fitting region 3A, the container 2 is moved in a direction parallel to the exterior surface 31 of the outer cover 3. In other words, the direction D of fitting and removal of the container 2 is the direction parallel to the exterior surface 31 of the outer cover 3.

In the following description, one direction in the direction D of fitting and removal is referred to as a first direction D1, and the other direction opposite to the one direction in the direction D of fitting and removal is referred to as a second direction D2. The first direction D1 is a direction in which the container 2 is moved when the container 2 is fitted into the fitting region 3A. The second direction D2 is a direction in which the container 2 is moved when the container 2 is removed from the fitting region 3A. When viewed from the front side of the image forming apparatus 100, the first direction D1 is a diagonally downward direction, and the second direction D2 is a diagonally upward direction.

The inner cover 4 is made of resin. The inner cover 4 may be made of sheet metal. The inner cover 4 covers the container 2 in the fitting region 3A from the inner side of the main body 1. In a state where the container 2 is fitted in the fitting region 3A, the container 2 is covered by the outer cover 3 from the outer side of the main body 1, and is covered by the inner cover 4 from the inner side of the main body 1. In other words, the container 2 is disposed between the outer cover 3 and the inner cover 4. Furthermore, in other words, a region between the outer cover 3 and the inner cover 4 is the fitting region 3A.

The inner cover 4 is supported to be turnable around a second axis A2 relative to the outer cover 3. The second axis A2 is an axis which extends in the forward/backward direction (X direction). In other words, the second axis A2 is an axis which is parallel to the first axis A1.

The inner cover 4 includes a pair of support point pins 40. Each of the pair of support point pins 40 is disposed on the second axis A2, and extends in the axial direction of the second axis A2. The inner cover 4 includes a pair of side walls 42 which are opposite each other in the forward/backward direction (in the axial direction of the second axis A2). The support point pins 40 are formed on the pair of side walls 42, respectively.

On the other hand, the outer cover 3 includes a pair of support point holes 30. Each of the pair of support point holes 30 is disposed on the second axis A2, and is opened in the axial direction of the second axis A2. The outer cover 3 includes a pair of side walls 32 which are opposite each other in the forward/backward direction (in the axial direction of the second axis A2). In the pair of side walls 42, the support point holes 30 are formed, respectively. The pair of support point holes 30 are through holes which penetrate the side walls 32 in the axial direction of the second axis A2. Each of the pair of side walls 32 is disposed outside in the axial direction of the second axis A2 relative to the side wall 42 on the same side. In other words, the pair of side walls 42 are disposed between the pair of side walls 32 in the forward/backward direction (that is, in the axial direction of the second axis A2).

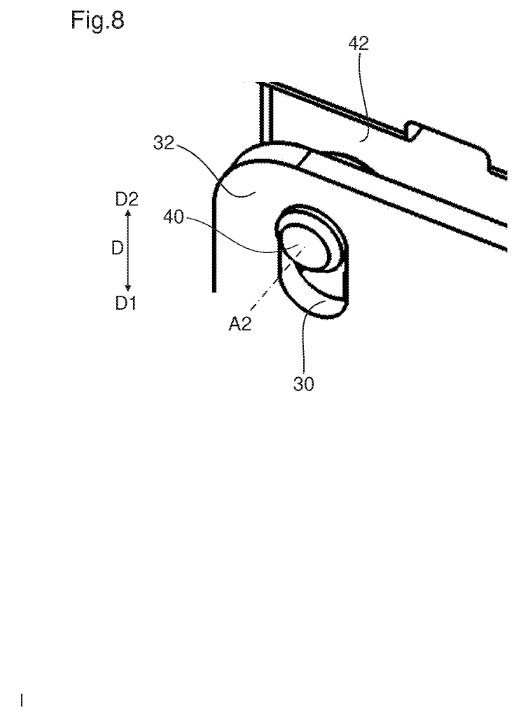

The pair of support point pins 40 are fitted into the pair of support point holes 30, respectively (see FIG. 8). Each of the pair of support point pins 40 is slidable around the second axis A2 relative to the support point hole 30 into which the support point pin 40 is fitted. In this way, the inner cover 4 is turnable with the second axis A2 serving as a support point. In FIG. 8, a state where the pair of support point pins 40 are fitted in the pair of support point holes 30 is enlarged and shown.

The container 2 in the fitting region 3A is sandwiched between a part 41 on an upper side of the inner cover 4 relative to the second axis A2 and the outer cover 3. In the following description, the part 41 of the inner cover 4 on the upper side is referred to as an inner cover upper part 41. The inner cover upper part 41 is displaced in a direction around the second axis A2 as the outer cover 3 is turned around the first axis A1. In other words, the inner cover upper part 41 is displaced in the direction around the second axis A2 according to the position of the outer cover 3.

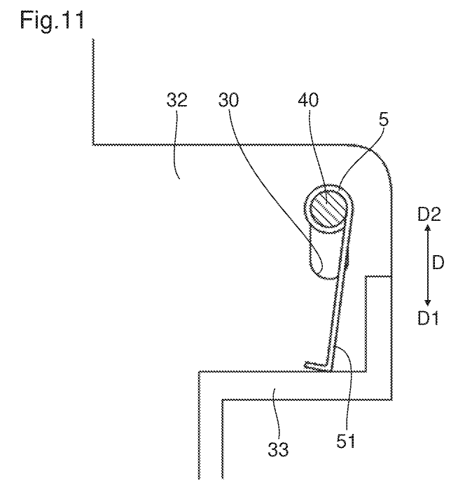

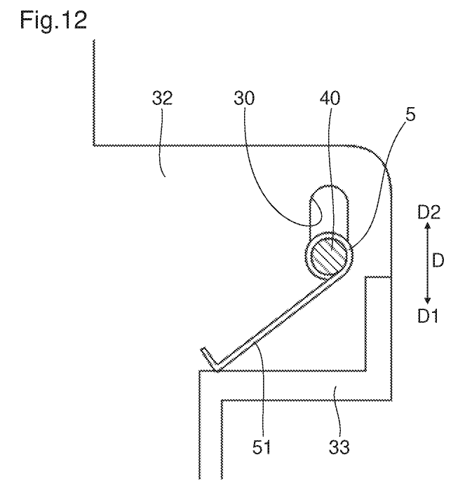

Specifically, the image forming apparatus 100 includes a torsion coil spring 5 (see FIGS. 11 and 12). The torsion coil spring 5 is disposed on at least one of the pair of support point pins 40. In other words, the torsion coil spring 5 is disposed on the second axis A2. The torsion coil spring 5 is disposed between the side wall 32 of the outer cover 3 and the side wall 42 of the inner cover 4 in the forward/backward direction (that is, in the axial direction of the second axis A2).

One of arm portions 51 of the torsion coil spring 5 engages with the spring support portion 33 of the outer cover 3 (see FIGS. 11 and 12). Although not shown in the figure, the other arm portion of the torsion coil spring 5 engages with the spring support portion of the inner cover 4. The torsion coil spring 5 generates a biasing force toward one side in the direction around the second axis A2. The inner cover 4 is biased by the biasing force of the torsion coil spring 5 (which is a biasing force that biases the inner cover 4 toward the one side in the direction around the second axis A2) in a direction in which the inner cover upper part 41 is moved away from the outer cover 3.

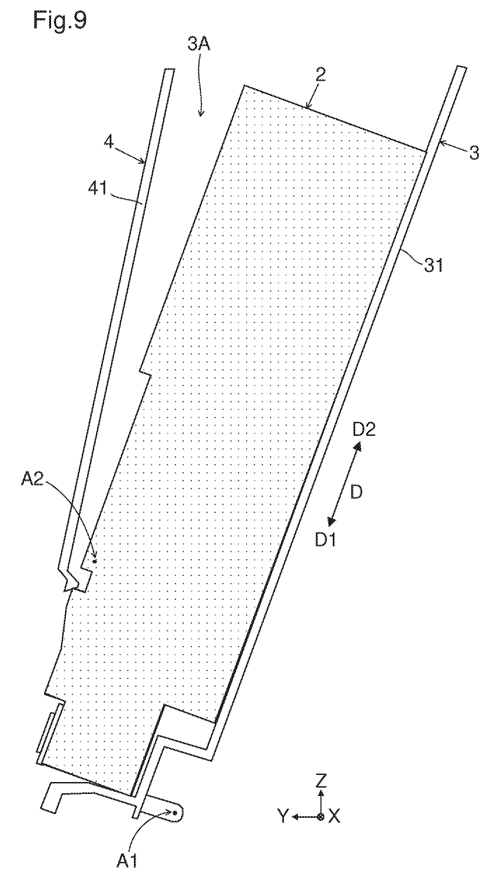

In the state where the outer cover 3 is in the open position, as shown in FIG. 9, the inner cover upper part 41 is maximally separated from the outer cover 3 by the biasing force of the torsion coil spring 5. In other words, the fitting region 3A is opened. In this way, the container 2 is removable from the fitting region 3A.

When the container 2 is fitted into or removed from the fitting region 3A, the user moves the container 2 in the direction D of fitting and removal. Here, the inner cover upper part 41 functions as a guide. The inner cover upper part 41 guides the movement of the container 2 in the direction D of fitting and removal. When the container 2 has been fitted into the fitting region 3A, the user closes the outer cover 3. In other words, the outer cover 3 is turned from the open position to the closed position.

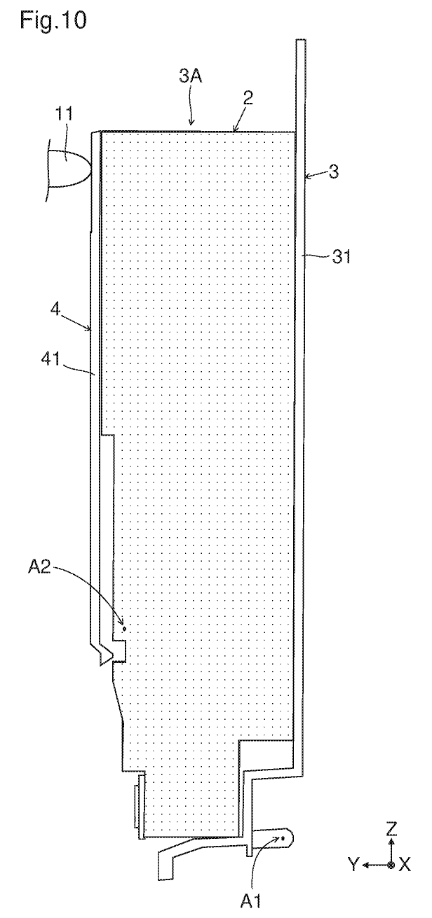

When the outer cover 3 is turned from the open position to the closed position, and the inner cover upper part 41 is moved into the main body 1, a main body member 11 (see FIG. 10) disposed inside the main body 1 makes contact with the inner cover upper part 41. Thereafter, when the outer cover 3 continued to be turned from the open position to the closed position, the main body member 11 presses the inner cover upper part 41 from the inner side to the outer side of the main body 1. Here, the inner cover upper part 41 is turned around the second axis A2 to be displaced against the biasing force of the torsion coil spring 5 in a direction in which the inner cover upper part 41 approaches the container 2 in the fitting region 3A.

In the state where the outer cover 3 is in the closed position, as shown in FIG. 10, the pressing of the inner cover upper part 41 performed by the main body member 11 is maintained. In this way, the container 2 in the fitting region 3A is sandwiched between the outer cover 3 and the inner cover upper part 41.

When the outer cover 3 is turned from the state shown in FIG. 10 to the open position, the inner cover upper part 41 is turned around the first axis A1 together with the outer cover 3, and thus the inner cover upper part 41 is displaced in a direction in which the inner cover upper part 41 is moved away from the main body member 11. The contact between the main body member 11 and the inner cover upper part 41 is finally released. Furthermore, the inner cover upper part 41 is turned around the second axis A2 by the biasing force of the torsion coil spring 5, and thus the inner cover upper part 41 is displaced in the direction in which the inner cover upper part 41 is moved away from the outer cover 3. In this way, a state shown in FIG. 9 is reached.

In FIGS. 9 and 10, for clarification of the container 2, a dotted pattern is applied to the container 2.

### Restriction of placement of empty container

In the present embodiment, the container 2 which is empty of the toner is restricted from being further placed into the main body 1. In other words, in the present embodiment, even when the container 2 which is empty of the toner is fitted into the fitting region 3A, and then the outer cover 3 is turned from the open position to the closed position, the outer cover 3 cannot be caused to reach the closed position. In the following description, the container 2 which is empty of the toner is shortly referred to as the empty container 2.

In the present embodiment, the inner cover 4 is displaceable between a first position and a second position relative to the outer cover 3. In this way, the empty container 2 is restricted from being further placed into the main body 1.

Specifically, in the present embodiment, as shown in FIGS. 6 to 8, the outer cover 3 includes, as the support point hole 30, a long hole which is elongated in the direction D of fitting and removal of the container 2. The support point pin 40 is disposed in the long hole serving as the support point hole 30, and thus the inner cover 4 is displaceable between the first position and the second position relative to the outer cover 3. In other words, the inner cover 4 is displaceable in the direction D of fitting and removal of the container 2 relative to the outer cover 3.

The position of the inner cover 4 shown in FIG. 6 is the first position. The position of the inner cover 4 shown in FIG. 7 is the second position. The second position is lower than the first position. FIG. 8 shows a relationship between the support point hole 30 and the support point pin 40 when the inner cover 4 is located in the first position.

When the container 2 is not fitted into the fitting region 3A, the inner cover 4 is held in the first position. When the container 2 is fitted into the fitting region 3A, the inner cover 4 is pressed by the container 2 to be displaced from the first position to the second position. Then, in the state where the container 2 is fitted in the fitting region 3A, the inner cover 4 is held in the second position. Although details will be described later, even when the empty container 2 is fitted into the fitting region 3A, that is, even when the inner cover 4 is pressed by the empty container 2, the inner cover 4 is not displaced from the first position to the second position.

The torsion coil spring 5 is used so that the inner cover 4 is displaceable between the first position and the second position. The torsion coil spring 5 is disposed as shown in FIGS. 11 and 12. FIGS. 11 and 12 schematically show a configuration when the inner side surface of the side portion 32 on one side is viewed from the inner side between the pair of side portions 32. FIG. 11 is a diagram when the inner cover 4 is in the first position, and FIG. 12 is a diagram when the inner cover 4 is in the second position. In FIGS. 11 and 12, only the support point pin 40 in the inner cover 4 is shown, and the side walls 42 and the like are omitted.

The coil portion of the torsion coil spring 5 is disposed on the support point pin 40 of the inner cover 4. One of the arm portions 51 of the torsion coil spring 5 engages with the spring support portion 33 of the outer cover 3. Although not shown in the figure, the other arm portion of the torsion coil spring 5 engages with the spring support portion of the inner cover 4. In this way, when the container 2 is not fitted into the fitting region 3A, a state shown in FIG. 11 is reached. When the container 2 is fitted in the fitting region 3A, a state shown in FIG. 12 is reached. In other words, the torsion coil spring 5 biases the inner cover 4 from the second position to the first position. In this configuration, the torsion coil spring 5 corresponds to a “biasing member”.

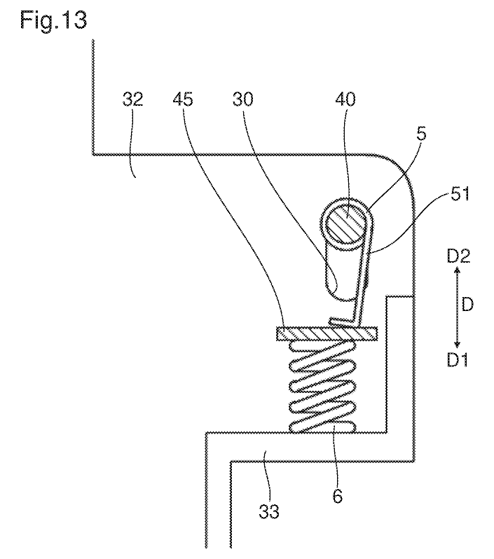

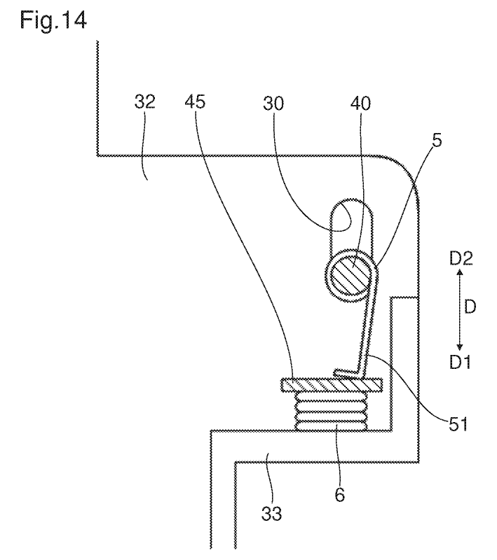

As a variation, a configuration as shown in FIGS. 13 and 14 may be adopted. In the variation, the inner cover 4 includes a spring support portion 45. The spring support portion 45 protrudes outward in the axial direction from the outer side surface of the side wall 42 on the same side as the side on which the torsion coil spring 5 is disposed in the pair of side walls 42. FIGS. 13 and 14 schematically show the configuration when the inner side surface of the side portion 32 on one side is viewed from the inner side between the pair of side portions 32. FIG. 13 is a diagram when the inner cover 4 is in the first position, and FIG. 14 is a diagram when the inner cover 4 is in the second position. In FIGS. 13 and 14, only the support point pin 40 and the spring support portion 45 in the inner cover 4 are shown, and the side walls 42 and the like are omitted.

In the variation, the image forming apparatus 100 includes a compression coil spring 6. In the variation, the compression coil spring 6 corresponds to the “biasing member”.

In the variation, one end portion of the compression coil spring 6 is supported by the spring support portion 33 of the outer cover 3, and the other end portion is supported by the spring support portion 45 of the inner cover 4. The compression coil spring 6 is disposed between the spring support portion 33 and the spring support portion 45. In this way, when the container 2 is not fitted into the fitting region 3A, a state shown in FIG. 13 is reached. When the container 2 is fitted in the fitting region 3A, a state shown in FIG. 14 is reached. In other words, the compression coil spring 6 biases the inner cover 4 from the second position to the first position. In the variation, one of the arm portions 51 of the torsion coil spring 5 engages with the spring support portion 45 of the inner cover 4, and the other arm portion engages with the spring support portion (not shown) of the outer cover 3.

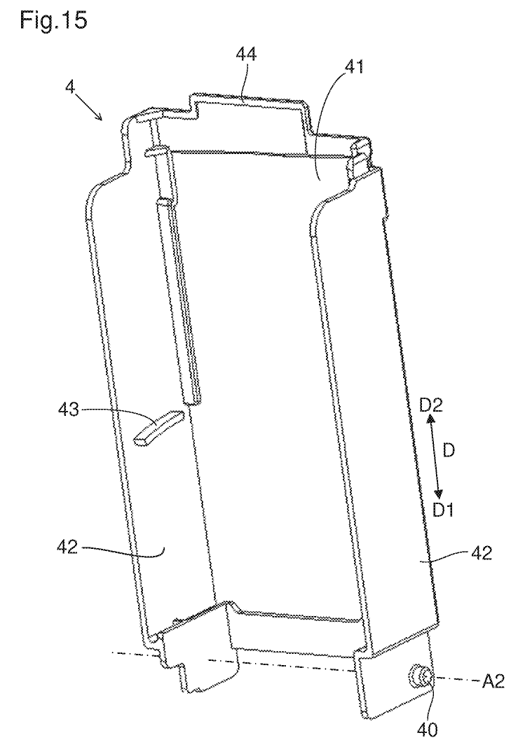

In the present embodiment, as shown in FIG. 5, the container 2 includes a rib 20. The rib 20 protrudes outward from the outer side surface of the container 2. As shown in FIG. 15, the inner cover 4 includes a protrusion to be pressed 43. The protrusion to be pressed 43 is disposed on the side wall 42 on the same side as the side on which the rib 20 is disposed in the pair of side walls 42. The protrusion to be pressed 43 protrudes inward from the inner side surface of the side wall 42 on the same side.

The rib 20 is disposed in the position of the outer side surface of the container 2 in which the rib 20 can make contact with the protrusion to be pressed 43 from above. When the container 2 is fitted into the fitting region 3A, the rib 20 makes contact with the protrusion to be pressed 43 from above. In this way, when the container 2 is fitted into the fitting region 3A, the protrusion to be pressed 43 is pressed by the rib 20 from above. In other words, when the container 2 is fitted into the fitting region 3A, the container 2 presses the inner cover 4 in the first direction D1.

The protrusion to be pressed 43 makes contact with the rib 20 regardless of whether the outer cover 3 is in the open position or in the closed position. In other words, the protrusion to be pressed 43 is pressed by the rib 20 from above regardless of whether the outer cover 3 is in the open position or in the closed position.

When the container 2 is not fitted into the fitting region 3A, the inner cover 4 is not pressed by the container 2. Hence, when the container 2 is not fitted into the fitting region 3A, the inner cover 4 is held in the first position by the biasing force of the torsion coil spring 5.

When the container 2 is fitted into the fitting region 3A, the inner cover 4 is pressed in the first direction D1 by the container 2 fitted into the fitting region 3A. Specifically, here, the protrusion to be pressed 43 is pressed by the rib 20. The container 2 presses the inner cover 4 in the first direction D1 by its weight.

In this way, when the container 2 is fitted into the fitting region 3A, the inner cover 4 is displaced from the first position to the second position against the biasing force of the torsion coil spring 5. Then, in the state where the container 2 is fitted in the fitting region 3A, the container 2 continues to press the inner cover 4, and thus the inner cover 4 is held in the second position against the biasing force of the torsion coil spring 5.

When the container 2 is fitted into the fitting region 3A, and the container 2 stores the toner (that is, the container 2 is not empty), the inner cover 4 is displaced by the weight of the container 2 from the first position to the second position against the biasing force of the torsion coil spring 5. For example, even when the container 2 is not full of toner, if the container 2 stores a predetermined amount of toner or more (amount less than the full amount), the inner cover 4 is displaced by the weight of the container 2 from the first position to the second position against the biasing force of the torsion coil spring 5.

On the other hand, when the container 2 is fitted into the fitting region 3A, and the container 2 is empty, the inner cover 4 is held in the first position against the biasing force of the torsion coil spring 5. In other words, the torsion coil spring 5 exerts the biasing force capable of holding, in the first position, the inner cover 4 pressed by the empty container 2. For example, even when the container 2 to be fitted into the fitting region 3A is not empty, if the amount of toner stored in the container 2 is less than the predetermined amount, the inner cover 4 may be held in the first position by the biasing force of the torsion coil spring 5.

Here, the inner cover 4 includes a protrusion 44. The protrusion 44 is disposed in the inner cover upper part 41. When the outer cover 3 is turned from the open position to the closed position in a state where the inner cover 4 is held in the first position, the protrusion 44 makes contact with the main body 1.

Specifically, as shown in FIGS. 6 and 15, the inner cover 4 includes, as the protrusion 44, a part which protrudes in the second direction D2 from the upper end of the inner cover upper part 41. The protrusion 44 protrudes outward in the radial direction of a circle with the first axis A1 in a center. The “outward in the radial direction of a circle with the first axis A1 in a center” means a direction away from the first axis A1 when viewed in the axial direction of the first axis A1.

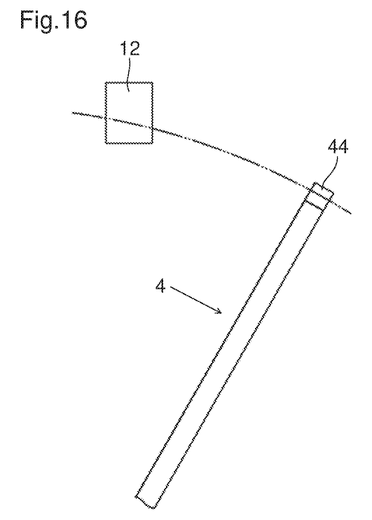

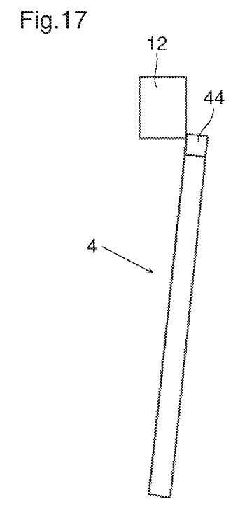

As shown in FIGS. 16 to 19, the main body 1 includes a restriction unit 12. The restriction unit 12 is disposed on the path of turning of the protrusion 44 when the outer cover 4 is turned from the open position to the closed position in the state where the inner cover 4 is held in the first position (see FIG. 16). The path of turning is indicated by a chain double-dashed line in FIG. 16. The protrusion 44 is turned along the path, and thus the protrusion 44 abuts against the restriction unit 12 (see FIG. 17).

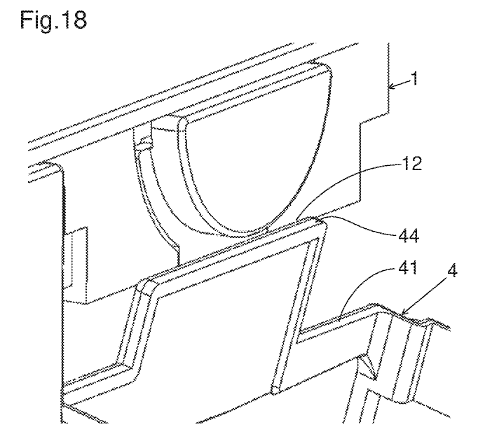

In the state where the inner cover 4 is held in the first position, the protrusion 44 is disposed in a position where the protrusion 44 abuts against the restriction unit 12. In this way, when the outer cover 3 is turned from the open position to the closed position in the state where the inner cover 4 is held in the first position, the inner cover 4 abuts against the restriction unit 12 (see FIG. 18). Consequently, the outer cover 3 is restricted from reaching the closed position. In other words, when the container 2 is not fitted into the fitting region 3A, and the container 2 to be fitted into the fitting region 3A is empty, the outer cover 3 is restricted from reaching the closed position.

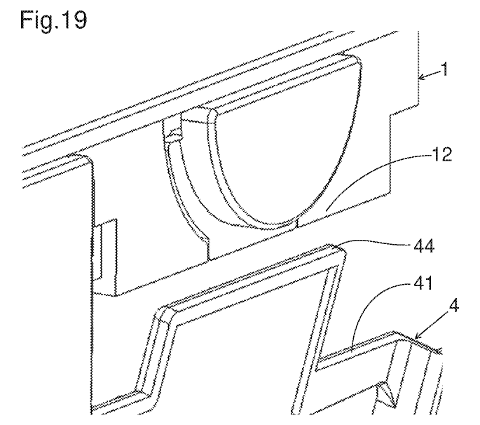

On the other hand, in a state where the inner cover 4 is held in the second position, the protrusion 44 is disposed in a position where the protrusion 44 does not abut against the restriction unit 12. In this way, when the outer cover 3 is turned from the open position to the closed position in the state where the inner cover 4 is held in the second position, the inner cover 4 does not abut against the restriction unit 12 (see FIG. 19). Consequently, the outer cover 3 can be caused to reach the closed position. In other words, when the container 2 to be fitted into the fitting region 3A stores the toner (that is, when the container 2 to be fitted into the fitting region 3A is not empty), the outer cover 3 can be caused to reach the closed position. The outer cover 3 reaches the closed position, and thus the container 2 is placed into the main body 1.

In the present embodiment, when as described above, the outer cover 3 is turned from the open position to the closed position in the state where the inner cover 4 is held in the first position, the inner cover 4 abuts against the restriction unit 12 to restrict the outer cover 3 from reaching the closed position. In this way, when the user of the image forming apparatus 100 turns the outer cover 3 from the open position to the closed position, if the container 2 is not fitted into the fitting region 3A or if the container 2 fitted in the fitting region 3A is empty, the outer cover 3 cannot be caused to reach the closed position. In other words, the outer cover 3 is kept opened relative to the main body 1.

When the outer cover 3 cannot be caused to reach the closed position from the open position, it is possible to cause the user to recognize that there is any problem. In other words, when the container 2 is not fitted into the fitting region 3A or when the container 2 fitted in the fitting region 3A is empty, it is possible to cause the user to recognize this state.

For example, a method of installing a sensor for detecting the fitting or removal of the container 2 relative to the fitting region 3A, and displaying a message related to the result of the detection performed by the sensor on the operation panel OP (see FIGS. 1 and 2) of the image forming apparatus 100 can be considered. However, it is likely that in this method, the user does not notice the message displayed on the operation panel OP. Moreover, the sensor for detecting the fitting or removal of the container 2 relative to the fitting region 3A is needed, and this leads to an increase in cost.

On the other hand, in the present embodiment, the outer cover 3 cannot be caused to reach the closed position from the open position, and thus it is possible to cause the user to reliably recognize that there is any problem. In other words, it is possible to reliably suppress an error in the fitting of the container 2 into the main body 1. The error in the fitting means that the outer cover 3 is turned from the open position to the closed position in a state where the container 2 is not fitted into the fitting region 3A or a state where the container 2 fitted in the fitting region 3A is empty.

In the present embodiment, the sensor for detecting the fitting or removal of the container 2 relative to the fitting region 3A is not needed, and thus it is possible to suppress an increase in cost.

In the present embodiment, a part of the main body 1 functions as the restriction unit 12. In other words, the part which functions as the restriction unit 12 is not provided separately. For example, the restriction unit 12 is a frame or the like in the main body 1. In this way, it is not necessary to change the design of the main body 1, and thus it is possible to suppress an increase in cost.

In the present embodiment, the protrusion 44 is provided in the inner cover 4. When the container 2 is not fitted into the fitting region 3A or when the container 2 fitted in the fitting region 3A is empty, the protrusion 44 abuts against the restriction unit 12 of the main body 1, and thus the outer cover 3 is restricted from reaching the closed position. In this way, with the simple configuration, it is possible to restrict the outer cover 3 from reaching the closed position.

In the present embodiment, the torsion coil spring 5 is used, and thus it is possible to easily displace the inner cover 4 from the first position to the second position. In this configuration, the biasing force of the torsion coil spring 5 is appropriately adjusted, and thus it is possible to easily displace the position of the inner cover 4 according to the state of the fitting of the container 2 into the fitting region 3A and the state of the storage of the toner in the container 2 fitted in the fitting region 3A.

It should be considered that the embodiment disclosed herein is illustrative in all respects, and not restrictive. The scope of the present disclosure is indicated not by the description of the above embodiment but by the scope of claims, and furthermore, meanings equivalent to the scope of claims and all changes in the scope are included therein.

What is claimed is:

1. An image forming apparatus comprising:
a main body that includes a printing unit;
a container that stores a toner used for printing in the printing unit;
an outer cover that
is supported to be turnable around a first axis orthogonal to an up/down direction relative to the main body,
includes a fitting region into which the container is removably fitted and
is displaceable between
an open position where the outer cover is turned around the first axis to expose the fitting region to an outside of the main body such that the container is removable from the fitting region and
a closed position where the container in the fitting region is placed in the main body; and
an inner cover that
is supported to be turnable around a second axis parallel to the first axis relative to the outer cover, and
sandwiches the container in the fitting region between the outer cover and the inner cover,
wherein the inner cover is displaceable between a first position and a second position relative to the outer cover,
when the container is not fitted into the fitting region, the inner cover is held in the first position,
when the container is fitted into the fitting region, the inner cover is pressed by the container to be displaced from the first position to the second position,
the main body includes a restriction unit and
when the outer cover is turned from the open position to the closed position in a state where the inner cover is held in the first position, the inner cover abuts against the restriction unit to restrict the outer cover from reaching the closed position.

2. The image forming apparatus according to claim 1,
wherein the inner cover includes a protrusion that protrudes outward in a radial direction of a circle with the first axis in a center,
the restriction unit is disposed on a path of turning of the protrusion when the outer cover is turned from the open position to the closed position in the state where the inner cover is held in the first position and
when the outer cover is turned from the open position to the closed position in the state where the inner cover is held in the first position, the protrusion abuts against the restriction unit to restrict the outer cover from reaching the closed position.

3. The image forming apparatus according to claim 1, further comprising:
a biasing member that biases the inner cover from the second position to the first position,
wherein when the container is not fitted into the fitting region, the inner cover is held in the first position by a biasing force of the biasing member and
when the container is fitted into the fitting region, the inner cover is displaced from the first position to the second position against the biasing force of the biasing member.

4. The image forming apparatus according to claim 3,
wherein when the container is fitted into the fitting region, and the container to be fitted into the fitting region stores the toner, the inner cover is displaced from the first position to the second position located below the first position by a weight of the container against the biasing force of the biasing member.

5. The image forming apparatus according to claim 3,
wherein the biasing member exerts the biasing force capable of holding, in the first position, the inner cover pressed by the container that is empty of the toner.
